(19) United States
(12) Patent Application Publication
(10) Pub. No.: US 2015/0268630 A1
(43) Pub. Date: Sep. 24, 2015

(54) Ultra-High Resolution Digital Holographic Camera

(71) Applicant: Medhat Azzazy, Laguna Niguel, CA (US)

(72) Inventor: Medhat Azzazy, Laguna Niguel, CA (US)

(21) Appl. No.: 13/908,758

(22) Filed: Jun. 3, 2013

(51) Int. Cl. G03H 1/04; G02B 27/09; G03H 1/00; G03H 1/14

(52) U.S. Cl. CPC G03H 1/0443; G03H 1/14; G02B 27/0927; G02B 27/0944; G03H 1/0005; G03H 1/0465; G03H 2001/0452; G03H 2001/0033

(57) ABSTRACT

A high resolution holographic imaging system. A laser illuminator is configured to operate in two or more wavelengths sequentially and a phase modulator element configured to operate at three or more phase positions. The illumination beam is split into two parts and propagated into optically diffractive elements to define “top hat” signals from the received Gaussian signals. One beam is directed onto a target area scene of interest and one beam is directed to an optical phase modulator element. The two beams are combined on an electronic imaging element for three phase positions of the phase modulator. The laser wavelength is shifted slightly and operation repeats. The data frames are digitized and a data processing unit implemented to calculate the complex amplitude and perform reconstruction of the image.

### CROSS-REFERENCE TO RELATED APPLICATIONS

This application claims the benefit of U.S. Provisional Patent Application No. 61/655,085, filed on Jun. 4, 2012 entitled “Ultra-High Resolution 3-D Digital Holographic Camera”, pursuant to 35 USC 119, which application is incorporated fully herein by reference.

This application is a continuation-in-part application of U.S. patent application Ser. No. 13/338,328, now pending, entitled “Stacked Micro-Channel Plate Assembly Comprising a Micro-Lens”, filed on Dec. 28, 2011, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of electronic imaging devices. More specifically, the invention relates to an ultra-high resolution holographic imaging device capable of producing high-definition images.

2. Background of the Invention

The complex problem of search, detection and recognition of buried, hidden or obscured devices such as improvised explosive devices or “IEDs” presently has no straight forward, general solution. A successful “counter-IED” system must rely on a spectrum of phenomenologies and sensing techniques that must be exploited in a variety of modes operating within a total engagement context. The nature of the IED threat is constantly evolving thus constantly degrading existing system solutions.

An important function of an operational counter-IED system construct is route searching performed at an early stage of, and during, vehicle convoy operations to detect, recognize, and alert convoys to potential IED activities and sites.

Effectiveness of route search operations can be significantly increased if changes along a planned route are detected prior to convoy passage thus alerting operators to potential IED threat locations and requires a high-resolution three-dimensional or “3-D” mapping of routes. Traditional two-dimensional and low-resolution 3-D approaches have not proven sufficiently effective due to natural evolution of scene observables and changes in viewing geometries and conditions.

A radical advance in sensing technologies is needed for effective route change detection which is provided in the imaging device of the instant invention.

### BRIEF SUMMARY OF THE INVENTION

The sensor system desirably can survey wide route swaths (˜90 meters) with a 3-D resolution of about 5 mm and efficiently store hundreds of kilometers of 3-D route data in the form of holograms. Real-time processing to compare holograms of the route taken at different times can be used to detect changes in the stored high resolution scene contents.

The laser illuminator source of the invention may be configured to operate in two or more wavelengths sequentially and the phase modulator element configured to operate at three or more phase positions. The exiting laser illuminator beam is split into two parts and each propagated into separate, dedicated optically diffractive elements to define “top hat” signals from the received Gaussian signals. One of the split beams is directed onto the target 3-D area scene of interest and one beam is directed to an optical phase modulator element such as a piezo-electric optical phase modulator in the system.

The two beams are combined and captured by an electronic imaging element which may be in the form of a focal plane array for the three phase positions of the piezo phase modulator. The laser wavelength is shifted slightly and operation repeals. In a preferred embodiment, a predetermined number of data frames are digitized and a data processing unit implemented to calculate the complex amplitude and perform reconstruction of the image.

In a first aspect of the invention, an imaging system is disclosed comprising an illuminator source comprising an electromagnetic beam output, a beam-splitter element configured for dividing the beam into an illuminator beam and a reference beam, an illuminator diffraction lens element disposed in an illuminator beam path, an optical phase modulator in a reference beam path configured to selectively modulate the phase of the reference beam, a reference diffraction lens element disposed in the reference beam path, an optical mixing element configured to mix a received illuminator beam reflection from an illuminated scene with the reference beam to define an optical input, and, a focal plane array element configured for receiving the optical input.

In a second aspect of the invention, at least one diffraction lens is configured for converting a Gaussian beam profile to top hat beam profile.

In a third aspect of the invention, the illuminator outputs an electromagnetic beam in the SWIR region having between a 1.4 to about a 3.0 micron wavelength.

In a fourth aspect of the invention, the reference beam is modulated at three separate phases.

In a fifth aspect of the invention, the focal plane array element comprises a stack of layers wherein the layers comprise a micro-lens array layer comprising at least one micro-lens element, a photocathode layer for generating a photocathode electron output in response to a predetermined range of the electromagnetic spectrum, a micro-channel plate layer comprising at least one channel for generating a cascaded electron output in response to the photocathode electron output and a readout circuit layer for processing the output of the channel.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a block diagram of a preferred embodiment of the system of the invention.

FIG. 2 depicts a generalized cross-section of a preferred embodiment of the system of the invention showing certain of its major elements.

FIG. 3 depicts an exemplar block diagram set-up for the phase-shifting digital holography system of the invention.

FIG. 4 illustrates a principle of surface profiling using the dual-wavelength phase shifting digital holography device and method of the invention.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

Turning now to the figures wherein like numerals define like elements among the several views, an ultra-high resolution digital holographic camera system and method 1 is disclosed and exploits the benefits of sensing techniques of phase-modulated digital holography.

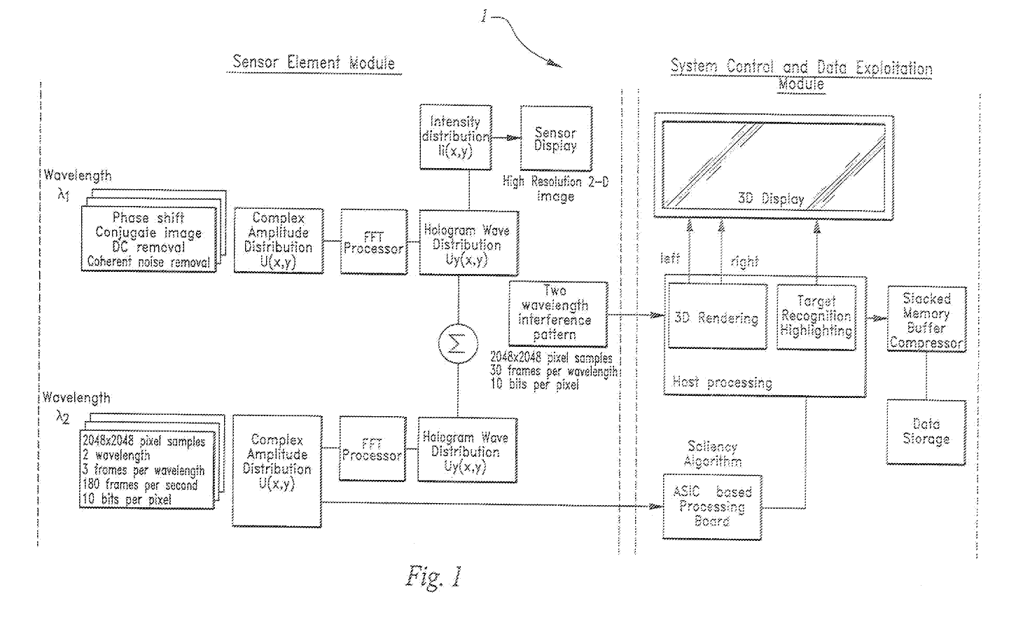

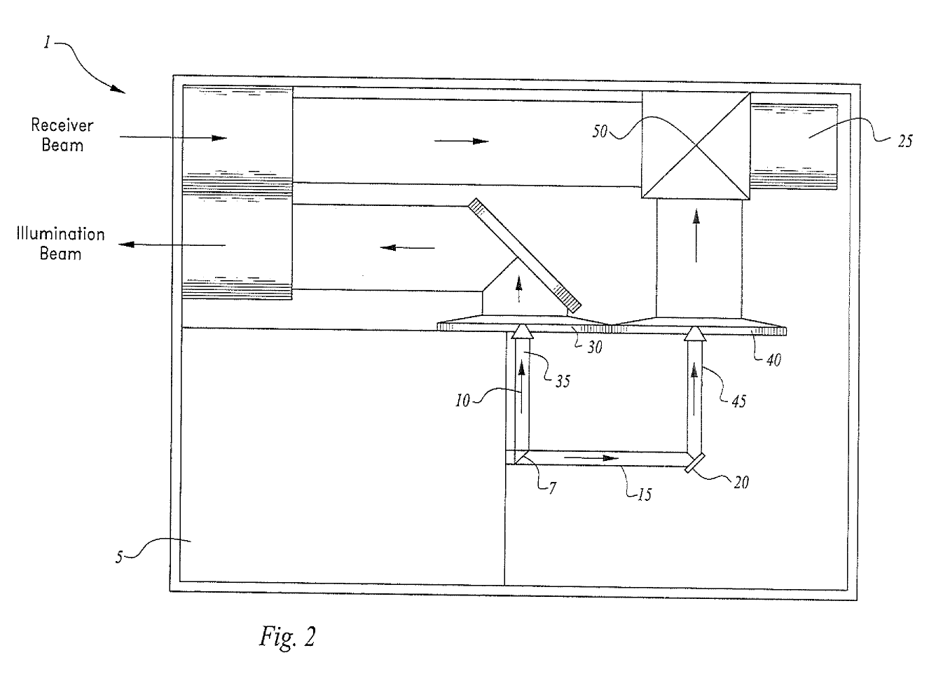

A three-dimensional, holographic sensor system 1 of the invention is illustrated in the block diagram of the invention of FIG. 1 and in the depiction of a preferred embodiment of the invention of FIG. 2

System 1 generally comprises a “sensing module” which comprises, in the illustrated preferred embodiment, a SWIR eye-safe laser scene illuminator source 5 for outputting an SI electromagnetic beam in about the 1.4 to 3 micron wavelength. The invention is not limited to the use of a SWIR laser and any other suitable laser illuminator element or electromagnetic wavelength source may be incorporated therein.

Illuminator 5 beam output is optically divided using an optical beam-splitter element 7 to define an illuminator beam 10 and a reference beam 15; each of which are prerequisites for hologram formation in the invention.

A phase modulator element 20 is provided to vary the phase of the reference beam 15 in line with a modulating signal and may comprise a piezo-phase optical modulator element. Phase modulator element 20 is configured to enable sequential laser wavelength sampling of reference beam 15 at a predetermined number of signal phases.

In a preferred embodiment, reference beam 15 is modulated at three phases of the laser wavelength whose outputs are processed to minimize phase ambiguities.

Phase modulator 20 may be a device based upon Pockel's effect where the refractive index along one or more axes is proportional to an externally applied electric field. By applying a voltage across the electrodes of an electro-optic crystal, the phase of light is changed as it passes through the crystal.

Reference beam 15 is spectrally modulated between two very closely spaced wavelengths as desired by the user and based upon the end use of the system. Two sequences of data are preferably taken at very short time intervals to permit removal of atmosphere and vibrational disturbances.

System 1 further comprises an electronic imaging sensor element 25 such as a focal plane array (“FPA”) along with related readout integrated circuitry (“ROIC”) which may be in the form of a stacked focal plane array module.

System 1 further may comprise an illumination beam diffraction lens 30 disposed in the illumination beam path 35 and a reference beam diffraction lens 40 disposed in the reference beam path 45, preferably disposed in the path between phase modulator 20 and the optical mixer element 50 of the system.

Each of illumination beam diffraction lens 30 and reference beam diffraction lens 40 may be configured for converting Gaussian illumination and reference beam intensity profiles to respective top hat intensity profiles.

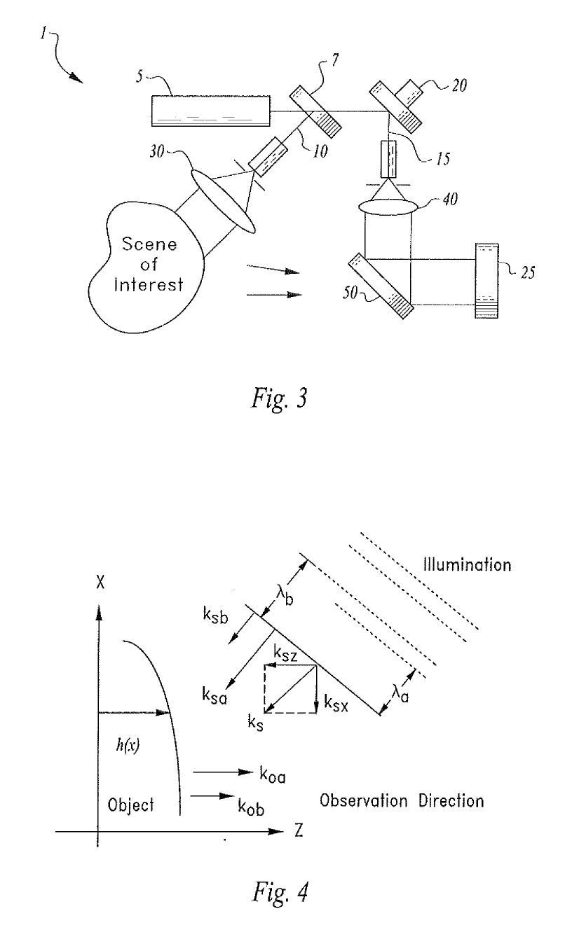

A further discussion of the digital holography principle of detection of the invention is as follows and is best illustrated in the exemplar block diagram set-up for the phase-shifting digital holography of the invention of FIG. 3.

Imaging laser source 5 beam is propagated into a suitable diffractive optic beam forming or shaping element to generate the above referenced top-hat energy intensity distribution.

The beam is then divided using the beam-splitting element so as to be incident upon the above referenced phase modulator element 20, which may comprise a piezo-electric transducer (PZT) mirror phase modulator, and the object that is the subject of the holographic imaging.

The light reflected from phase modulator element 20 and the imaged object is then combined by a second beam-splitting or optical mixing element and captured by the system focal plane array (FPA) 25.

The resultant video signal output is then converted using an analog-to-digital converter (“ADC”) and stored in system memory, which system 1 may be embodied in a hand-held device. A control processing unit in system 1 is provided to calculate the complex amplitude and to reconstruct the image from the signal.

The reconstructed images may desirably be transferred into a personal computer or similar computing element that is configured to identify regions of interest in the images, detect saliency, and for display of 3-D images of the object.

The interference pattern at the FPA plane 25 of the system may be expressed as a combination of the following four terms:

I(x,y)=U_{R}(x,y)U_{R}*(x,y)+U(x,y)U*(x,y)+U(x,y)U_{R}*(x,y)+U_{R}(x,y)U*(x,y) (1)

Where U_{R} and U are the complex amplitude of the reference and object waves. Taking into consideration phase shift, δ introduced by the PZT phase modulator element 20 on the reference beam, the intensity recorded by the FPA 25 is thus represented by:

I(x,y:δ)=|U_{R}|²+|U|²+UU_{R}*exp(−iδ)+U*U_{R}exp(iδ) (2)

Recording of the three phase shifted holograms obtained from the phase shifts of δ=0, π/2, and π yields the complex amplitude of the object wave given by:

$$U ( x , y ) = \frac{1 - i}{4 {U}_{R}^{*}} \{ I ( x , y \text{:} 0 ) - I ( x , y \text{:} \frac{π}{2} ) + i [ I ( x , y \text{:} \frac{π}{2} ) - I ( x , y \text{:} π ) ] \} \qquad ( 3 )$$

By carrying out a Fresnel transformation on Equation (3), one obtains the complex amplitude at a distance Z from the FPA 25:

$${U}_{I} ( X , Y , Z ) = \int \int U ( x , y ) exp [ i \frac{2 π}{λ} \frac{{( X - x )}^{2} + {( Y - y )}^{2}}{2 Z} ] d x d y \qquad ( 4 )$$

Letting Z=−zₒ leads to the complex amplitude at the object plane.

For range measurements, two sets of phase-shifted holograms for wavelength λₐ and λ_{b} are recorded as shown in FIG. 4.

The corresponding wave vectors of the object illumination beam are represented as kₐ and k_{b} where k=2λ/\hat{λ}. Denote the wave vectors along the observation direction by kₐₒ and k_{bo}. Let the height from the reference plane be denoted by h(x,y), then the difference in the reconstructed phases corresponding to the identical object points is given by:

$$\begin{matrix}Δφ = arg [ {U}_{1 , a} ( x , y , - {z}_{o} ) {U}_{1 , b}^{*} ( x , y , - {z}_{o} ) ] \\ = - ( {k}_{saz} - {k}_{sbz} - {k}_{oaz} - {k}_{obz} ) h ( x , y ) - ( {k}_{sax} - {k}_{sbx} ) x\end{matrix} \qquad ( 5 )$$

Equation 5 assumes the incident plane is parallel to the x-z plane and the reference plane is the x-y plane. The first term in Equation 5 means the phase difference is proportional to the range (surface height), and the second term stands for the tilt component, which can be eliminated by employing the normal incidence.

FIG. 4 depicts a principle of surface profiling using the dual-wavelength phase shifting digital holography method and device of the invention.

Denoting the wavelength of the illumination by λₐ and λ_{b} at the normal incidence and reconstructing each of the holograms with the same wavelength as in the recording, the difference is expressed as:

$$\begin{matrix}Δφ ( x , y ) = - 2 ( {k}_{a} - {k}_{b} ) h ( x , y ) \\ = - \frac{4 π h ( x , y )}{A}\end{matrix} \qquad ( 6 )$$

Which means the contours of the object surface height (range) may be determined with a sensitivity proportional to the synthetic wavelength defined as

$$\frac{1}{A} = \frac{1}{{λ}_{a}} - \frac{1}{{λ}_{b}} \qquad ( 7 )$$

In conventional dual wavelength holographic interferometry, the reconstruction is performed with the same wavelength as one of the recording wavelength. Therefore wavelength aberration can cause some errors.

The contour sensitivity of the system is given by:

$$Δ h = \frac{A}{2} = \frac{{λ}^{2}}{2 Δλ} \qquad ( 8 )$$

Where λₐ=λ_{b}, and λ_{b}=λ+Δλ, and Δλ<<λ.

In prior art 3-D imaging systems, spatial resolution is determined the pixel size in the object space. The objective lens of the system plays a large role in the system performance. The combination of pixel size and the effective focal length of the objective lens substantially determines the instantaneous field of view and hence the resolution of the system at a specified range.

The range resolution of such a prior art system is determined by the “range concept”; e.g., time of flight, stereo photography, and hardware, e.g., clock speed, distances and angles between cameras. In these systems laser coherence and coherence length are not a major requirement.

In digital holography, however the spatial resolution is determined by the pixel size in the image plane. Digital holography systems are generally “lens-less” Fourier transform optical systems. The range resolution is thus determined by the synthetic wavelength as described in Equation 8. Laser coherence length is an essential parameter ill such digital holography systems.

Table 1 is an exemplar summary of range resolutions as a function of center laser wavelengths and wavelength shifts.

Table 1 assumes four conventional laser wavelengths (UV lasers, telecommunications laser diodes, solid state Nd-YAG and eye-safe laser wavelength range). The wavelengths in Table 1 are selected to correspond to commercially available off-the-shelf detector arrays.

TABLE 1
Wavelength shift and range resolution

| Range | Center | Wavelength shift |
|---|---|---|
| resolution (μm) | wavelength (μm) | (nm) |
| 10 | 0.4 | 8 |
| | 0.8 | 32 |
| | 1.06 | 56 |
| | 1.57 | 123 |
| 25 | 0.4 | 3.2 |
| | 0.8 | 12.8 |
| | 1.06 | 22.5 |
| | 1.57 | 49.3 |

There are several methods available to achieve the desired wavelength shift in the invention. For laser diodes, the output wavelength may be slightly shifted through current control. The shift is preferably a few tens of nanometers. Note this is consistent with the resolution values given in Table 1.

Solid state lasers and/or fiber lasers for the eye safe region may be excited using two seed sources with a predetermined wavelength separation. This desirably results in a laser wavelength separation on the order of, for instance, 50 nanometers which is consistent with the results in Table 1.

In order to more closely adhere to the sampling method herein, each hologram fringe is desirably resolved using about 2 to 3 pixels (2-3 points per fringe). Assuming a field of view of one meter and 2048×2048 detector pixels in a two-dimensional focal plane array detector set, then each pixel covers about 488 μm in the object space.

Since the sampling method uses about 2-3 points per pixel, then each pixel covers about 1464 μm in the object space. For signal-to-noise ratios of about 100 or more, fringe interpolation techniques permit a resolution of about 1/30^{th} of a fringe.

As can thus be seen, spatial resolutions of the order of 50 μm are obtained from the device and method of the invention.

Desirably, sensor system 1 requires no scanning or focusing and in a preferred embodiment, the sensing module is capable of producing about 30 hologram “frames” per second, enabling accurate observation and detailed characterization of observed sites.

A second major element of the sensor system 1 of the invention is a “control and data exploitation module”. The control module may be configured to serve three primary purposes: 1) housing and execution of system control functions, 2) hosting data exploitation and display processing, and, 3) memory for large image databases produced by the system.

The sensor system of the invention provides significant improvements over prior art systems.

The output of the sensing module is an enhanced hologram containing 3-D image information of the surveillance volume.

The resulting holograms may undergo interference processing for noise reduction and scene image enhancement using suitable interference processing circuitry.

Sensor system 1 of the invention integrates state-of-the-art technologies and technologies drawn from a wide spectrum of the electro-optics technology base which, in the preferred embodiment, comprise a high-sensitivity receiver to record the optically-formed holograms having a high signal-to-noise ratio to enable retrieving low-contrast fringe structure from the holograms to achieve 3-D images with millimeter-class resolutions.

In an alternative preferred embodiment, focal plane array 25 of the invention may comprise an electronic micro-channel module as is disclosed in U.S. patent application Ser. No. 13/338,328, now pending, entitled “Stacked Micro-Channel Plate Assembly Comprising a Micro-Lens” wherein the focal plane array comprises a stack of layers is provided wherein the layers comprise a micro-lens array layer comprising at least one micro-lens element, a photocathode layer for generating a photocathode electron output in response to a predetermined range of the electromagnetic spectrum, a micro-channel plate layer comprising at least one channel for generating a cascaded electron output in response to the photocathode electron output and a readout circuit layer for processing the output of the channel.

The embodiment may comprise a data processing application specific integrated circuit or “ASIC” and a “stacked” microelectronic image processing module to handle the giga-pixel sampling and tera-ops/sec processing rates and for executing real-time processing algorithms for mission real-time exploitation, interpretation, and display.

In an exemplar route clearance operation, two of the sensor systems each sample a (30 m)³ of space and produce a digital hologram from each space observation. Up to 30 such holograms may be produced each second from each camera.

Operating in a “whisk broom” fashion, the two cameras can provide an ultra-high resolution database of a scene swath along the route flown by a survey aircraft such as Constant Hawk or UAS.

Storing the data as digital holograms is the most efficient way to store the resultant sensor image data. Planned routes can thus be extensively and repeatedly mapped.

In “holographic” space, holograms of a scene taken at different times may be correlated in real-time. The degree of de-correlation is beneficially used a measure of scene change. In areas where de-correlation indicates change, the holograms can be processed for 3-D display in “image” space for operator observation and, if desired, auto-processing used to assist in identifying what has changed in the scene. Since this approach uses active lasers with eye-safe levels of illumination, variations in natural lighting conditions will not affect the system observations.

Many alterations and modifications may be made by those having ordinary skill in the all without departing from the spirit and scope of the invention. Therefore, it must be understood that the illustrated embodiment has been set forth only for the purposes of example and that it should not be taken as limiting the invention as defined by the following claims. For example, notwithstanding the tact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. An imaging system comprising:
an illuminator source comprising an electromagnetic beam output,
a beam-splitter element configured for dividing the beam into an illuminator beam and a reference beam,
an illuminator diffraction lens element disposed in an illuminator beam path,
an optical phase modulator disposed in a reference beam path configured to selectively modulate the phase of the reference beam,
a reference diffraction lens element disposed in the reference beam path,
an optical mixing element configured to mix a received illuminator beam reflection from an illuminated scene with the reference beam to define an optical input, and,
a focal plane array element configured for receiving the optical input.

2. The system of claim 1 wherein at least one diffraction lens is configured for converting a received Gaussian beam profile to top hat beam profile.

3. The system of claim 1 wherein the illuminator outputs an electromagnetic beam in the SWIR region having about a 1.4 to about a 3.0 micron wavelength.

4. The system of claim 1 wherein the reference beam is modulated at three separate phases.

5. The system of claim 1 wherein the focal plane array element comprises a stack of layers is provided wherein the layers comprise a micro-lens array layer comprising at least one micro-lens element, a photocathode layer for generating a photocathode electron output in response to a predetermined range of the electromagnetic spectrum, a micro-channel plate layer comprising at least one channel for generating a cascaded electron output in response to the photocathode electron output and a readout circuit layer for processing the output of the channel.
